(19) United States
(12) Patent Application Publication
(10) Pub. No.: US 2025/0206360 A1
(43) Pub. Date: Jun. 26, 2025

(54) ELECTRONIC BRAKING INDICATION SYSTEM FOR AT LEAST ONE VEHICLE, PARTICULARLY AT LEAST ONE RAILWAY VEHICLE

(71) Applicant: Faiveley Transport Italia S.P.A., Piossasco (Torino) (IT)

(72) Inventors: Matteo Frea, Cantalupa (Torino) (IT); Guillaume Bonhomme, Amiens (FR)

(73) Assignee: Faiveley Transport Italia S.P.A., Piossasco (Torino) (IT)

(21) Appl. No.: 18/848,339

(22) PCT Filed: Mar. 16, 2023
(86) PCT No.: PCT/IB2023/052560

§ 371 Date: Sep. 18, 2024

(30) Foreign Application Priority Data
Mar. 18, 2022 (IT) 102022000005372

(51) Int. Cl. B61L 15/00; B60Q 1/44; B60T 13/74; B60T 17/22; B61H 1/00

(52) U.S. Cl. CPC B61L 15/00; B60T 17/22; B61H 1/003; B60Q 1/444; B60T 13/746

(57) ABSTRACT

The invention relates to electronic braking indication systems for at least one vehicle, which systems comprise at least one electromechanical actuator (202) arranged to apply a braking force (F). In one aspect the invention relates to an electronic braking indication system comprising at least one force sensor means (204) arranged to measure the applied braking force (F), at least one electronic visual signaling device (206), comprising at least one first and one second electronic light source (208, 210), and at least one control means (212) arranged to receive the measured value of the braking force (F) and: a) switch on the first electronic light source (208) when the value of the braking force (F) is lower than a first threshold (THRESHOLD 1); b) switch on the second electronic light source (210) when the value of the braking force (F) is greater than the first threshold (THRESHOLD 1). In another aspect the invention relates to an electronic braking indication system comprising at least one force sensor means (204) arranged to measure the applied braking force (F), at least one electronic visual signaling device (206), comprising at least one first and one second electronic light source (208, 210), and at least one control means (212) arranged to receive the measured value of the braking force (F) and: a) switch on said first electronic light source (208) when said measured value of the braking force (F) is lower than or equal to a first threshold (THRESHOLD 1); b) switch on said second electronic light source (210) when said measured value of the braking force (F) is greater than or equal to a second threshold (THRESHOLD 2) different from said first threshold (THRESHOLD 1).

### TECHNICAL FIELD

The present invention relates, in general, to the field of vehicles, for example railway vehicles; in particular, the invention relates to an electronic braking indication system for at least one vehicle and to a vehicle comprising such an electronic braking indication system.

### PRIOR ART

The prior art will be described below with particular reference to the field of railway vehicles. Nevertheless, that which is described in the following may also apply, where possible, to vehicles in other fields.

Railway vehicles, whether intended for the transport of passengers or goods, usually have a pneumatic or electro-pneumatic braking system.

This braking system comprises a brake pipe designed to convey a pressurized fluid and auxiliary tanks for storing the compressed air.

Various pneumatic or electro-pneumatic actuators installed along the vehicle are arranged to receive this fluid, through respective pipes, and convert (in some cases even regulate) said pressure into a braking force to be applied on one or more disc-pad and/or wheel-shoe couplings.

For multiple reasons of safety and/or to support the monitoring of rolling stock, it is necessary to provide the vehicle with a system that allows the state of application of the brake to be visually checked, as required for example by the European standard EN 15220.

For example, for safety reasons, it is necessary to verify that, if the driver has commanded the release of the braking, the braking has actually been released by all the pneumatic or electro-pneumatic actuators. Failure to release the braking by a pneumatic or electro-pneumatic actuator could lead to dragging of the wheel(s) associated with this actuator, with consequent damage to the rolling stock and infrastructure and risk of derailment for the vehicle.

To carry out such a check, known vehicles include braking indicators installed on the vehicle so as to be visible from outside the vehicle.

An example of a braking indicator 100 according to the prior art is illustrated in FIG. 1.

In particular, the left side of FIG. 1 shows the braking indicator in a condition of braking released and the right side of FIG. 1 shows the braking indicator in a condition of applied braking.

Each braking indicator is associated with one or more pneumatic or electro-pneumatic actuators and comprises a substantially box-shaped structure 102.

Inside the structure 102, there is a plate 104 which is divided into two colors C1 and C2, for example green and red.

The box-shaped structure comprises an opening 106 through which a portion of the plate 104 can be viewed.

Looking at the left side of FIG. 1, when the braking force is released, i.e. the pressure of the braking fluid 103 is below a predetermined threshold, a predetermined elastic element 108 associated with the plate 104 will keep the plate in a position such that the opening 106 of the box-shaped structure 102 shows the plate portion having the color C1, i.e. green.

Looking at the right side of FIG. 1, when the braking force is applied, i.e. the pressure of the braking fluid is greater than a predetermined threshold, the predetermined elastic element 108 associated with the plate 104 will be compressed so that the plate 104 will be in such a position that the opening 106 of the box-shaped structure will show the plate portion having the color C2, i.e. red.

When the vehicle is for example in a station or marshaling yard, before departure, the driver will be able to release the braking. Once the braking release command has been given, an operator positioned outside the vehicle will take care of viewing all the braking indicators 100 and checking that the color C1, i.e. green, indicative of the occurred release of the braking by the respective pneumatic or electro-pneumatic actuator(s), can be seen from the respective openings 106. If there is a braking indicator 100 which shows the color C2, i.e. red, from the opening 106, the operator will signal that a pneumatic or electro-pneumatic actuator has remained blocked in a braking condition or that it will in any case signal the presence of an anomaly.

Today, the rail vehicle industry is experiencing a transition from pneumatic/electro-pneumatic braking systems to electromechanical braking systems.

Disadvantageously, the braking indicators 100 that were used for pneumatic/electro-pneumatic braking systems cannot be used for electromechanical braking systems. This is due to the fact that the operation of the braking indicators 101 of the pneumatic or electro-pneumatic braking systems was based on the monitoring of a pressure value of the braking fluid, which is no longer present for electromechanical braking systems.

### SUMMARY OF THE INVENTION

An object of the present invention is therefore to provide a solution, for electromechanical braking systems, which produces visual information of the state of application of the brake.

The above and other objects and advantages are achieved, according to one aspect of the invention, by an electronic braking indication system for at least one vehicle, particularly at least one railway vehicle, having the features defined in the respective independent claim 1 or 2, and by a vehicle having the features defined in claim 15. Preferred embodiments of the invention are defined in the dependent claims, the content of which is to be understood as an integral part of the present description.

### BRIEF DESCRIPTION OF THE DRAWINGS

The functional and structural features of some preferred embodiments of an electronic braking indication system for at least one vehicle, particularly at least one railway vehicle, and of a vehicle according to the invention, will now be described. Reference is made to the accompanying drawings, wherein:

FIG. 1 illustrates a braking indicator according to the prior art;

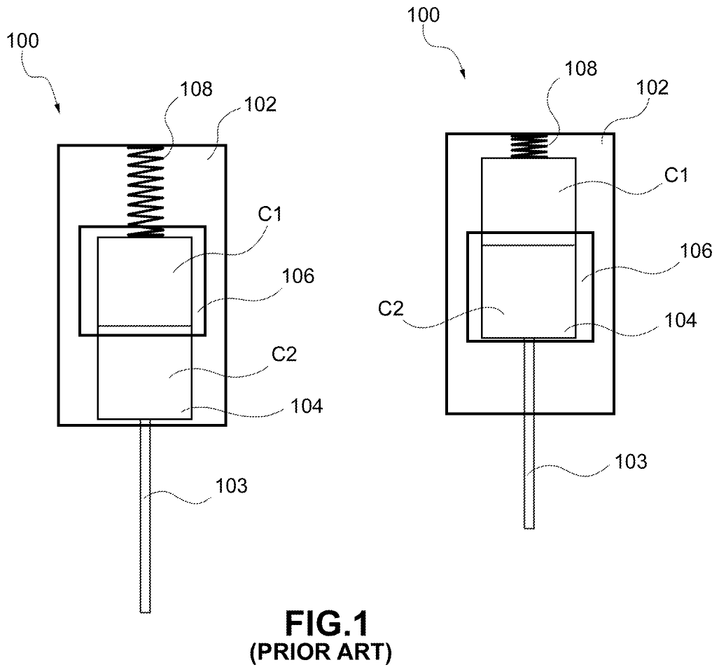

FIG. 2 illustrates an embodiment of an electronic braking indication system for at least one vehicle, particularly a railway vehicle, according to this invention;

FIG. 3 illustrates an exemplary explanatory graph of the operation of the system showing an electronic braking indication system for at least one vehicle when only a first threshold is present;

FIG. 4 illustrates an exemplary explanatory graph of the operation of the system showing an electronic braking indication system for at least one vehicle when a first threshold and a second threshold are present;

FIG. 5 illustrates a further embodiment of an electronic braking indication system for at least one vehicle, particularly a railway vehicle, according to this invention;

FIG. 6 illustrates an even further embodiment of an electronic braking indication system for at least one vehicle, particularly a railway vehicle, according to this invention;

FIG. 7 illustrates an electromechanical actuator according to the prior art.

### DETAILED DESCRIPTION

Before explaining in detail a plurality of embodiments of the invention, it should be clarified that the invention is not limited in its application to the design details and configuration of the components presented in the following description or illustrated in the drawings. The invention may assume other embodiments and be implemented or constructed in practice in different ways. It should also be understood that the phraseology and terminology have a descriptive purpose and should not be construed as limiting. The use of “include” and “comprise” and the variations thereof are intended to cover the elements set out below and the equivalents thereof, as well as additional elements and the equivalents thereof.

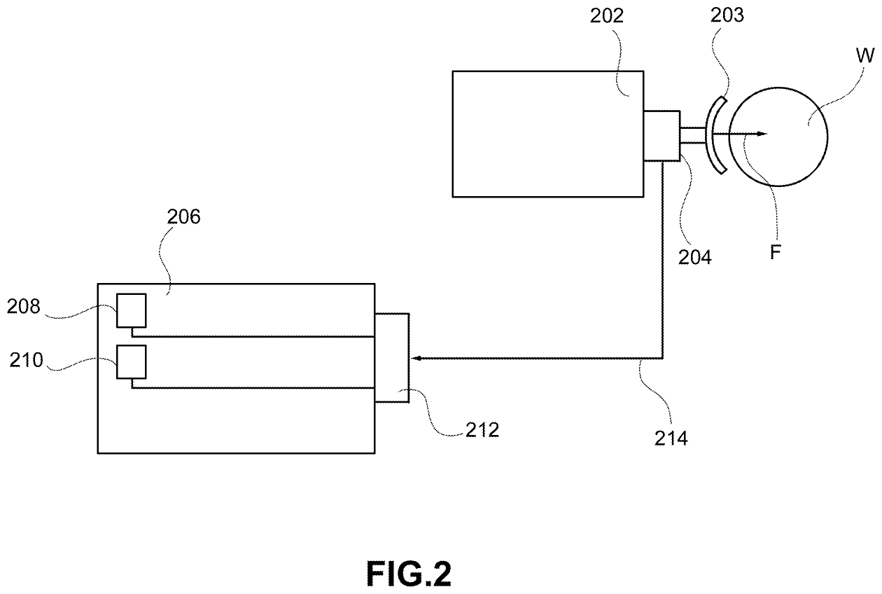

Referring initially to FIG. 2, an embodiment of an electronic braking indication system for at least one vehicle, particularly a railway vehicle, is shown.

The vehicle comprises at least one electromechanical actuator 202 arranged to apply a braking force F to at least one wheel W of the vehicle or to at least one braking element associated with at least one wheel W of the vehicle or an axle to which at least one wheel W of the vehicle is mounted.

For example, the braking element, when associated with at least one wheel W of the vehicle, may be a disc brake mounted to the wheel. For example, the at least one braking element, when associated with the axle to which the at least one wheel W is mounted, may be a disc brake mounted to the axle.

For example, the at least one electromechanical actuator 202, for applying the braking force F, may comprise braking force application means 203, such as, for example, a braking shoe, disc brake calipers, etc.

The electronic braking indication system comprises at least one force sensor means 204 arranged to measure a value of said braking force F applied by said at least one electromechanical actuator 202.

The value of said braking force may be for example the instantaneous value of the force of said applied braking force F.

The electronic braking indication system further comprises at least one electronic visual signaling device 206, comprising at least one first electronic light source 208 and at least one second electronic light source 210.

Moreover, the electronic braking indication system comprises at least one control means 212 arranged to receive the measured value of said braking force F.

For example, the at least one control means 212 may be or comprise at least one of a microprocessor, a processor, a microcontroller, a controller, a PLC, an FPGA, or the like.

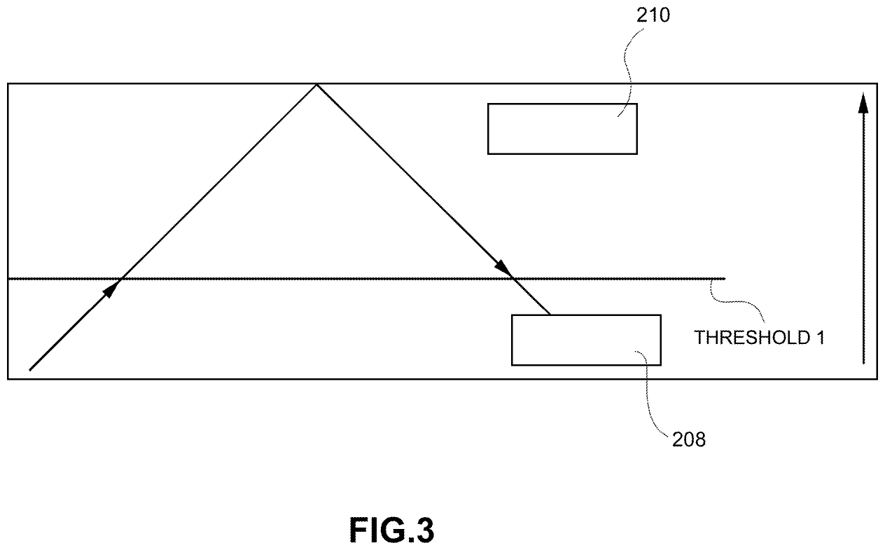

In a first embodiment, the at least one control means is arranged to:
a) switch on said first light source 208 when said measured value of the braking force F is lower than a first threshold (indicated in FIG. 3 as THRESHOLD 1);
b) switch on said second light source 210 when said measured value of the braking force F is greater than said first threshold (THRESHOLD 1).

FIG. 3 illustrates an exemplary explanatory graph of the operation of the system showing an electronic braking indication system for at least one vehicle when only a first threshold, i.e. THRESHOLD 1, is present.

When said measured value of the braking force F is equal to the first threshold, the following control strategies may be applied interchangeably:
the control means 212 is arranged to switch on said first light source 208; or
the control means 212 is arranged to switch on said second light source 210.

Or, when the measured value of the braking force F is equal to the first threshold, the control means 212 may be arranged to keep on the light source 208, 210 which was switched on before the first threshold THRESHOLD 1 was reached.

In a second embodiment, as for the previous embodiment, the electronic braking indication system for at least one vehicle, particularly at least one railway vehicle, comprises at least one force sensor means 204 arranged to measure a value of said braking force F applied by said at least one electromechanical actuator 202, at least one electronic visual signaling device 206 comprising at least one first electronic light source 208 and at least one second electronic light source 210.

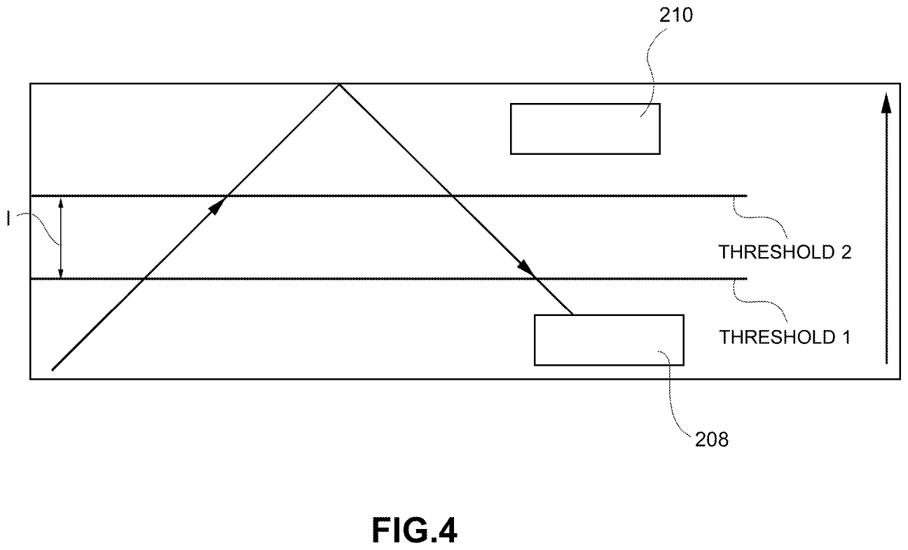

Unlike the first embodiment, the at least one control means 212 is arranged to receive the measured value of said braking force F and:
a) switch on said first electronic light source 208 when said measured value of the braking force F is lower than or equal to a first threshold (indicated in FIG. 4 as THRESHOLD 1);
b) switch on said second electronic light source 210 when said measured value of the braking force F is greater than or equal to a second threshold (indicated in FIG. 4 as THRESHOLD 2) different from said first threshold.

Preferably, when both the first threshold and the second threshold are present, the second threshold can be greater than said first threshold.

FIG. 4 illustrates an exemplary explanatory graph of the operation of the system showing an electronic braking indication system for at least one vehicle when a first threshold and a second threshold are present. With reference to FIG. 4, a range of hysteresis values I can be created between the first threshold (THRESHOLD 1) and the second threshold (THRESHOLD 2).

In the hysteresis band, the light source 208, 210 which was switched on before entering the hysteresis value range I can remain on. In other words, if the measured braking force F is decreasing, but had exceeded the second threshold (THRESHOLD 2) which led to the switching on of the second electronic light source 210, the at least one control means 212 will be able to keep the second electronic light source 210 switched on until the measured braking force F has reached or has fallen below the first threshold (THRESHOLD 1). Conversely, if the measured braking force F is increasing, but had fallen below the first threshold (THRESHOLD 1) which led to the switching on of the first electronic light source 208, the at least one control means 212 will be able to keep the first electronic light source 208 switched on until the measured braking force F has reached or exceeded the first threshold (THRESHOLD 1).

For all embodiments described, the at least one control means 212 could preferably be comprised in the at least electromechanical actuator. In such a case, the control means 212 may be the control means usually installed in an electromechanical actuator for controlling its actuation. Or, the at least one control means 212 may be a further suitable control means included in the electromechanical actuator.

When a plurality of electromechanical actuators are present, each of them may comprise a respective control means. In this case, there may be a plurality of control means 212, and a plurality of first electronic light sources 208 and second electronic light sources 210. Each control means will be able to control the switching on of at least one respective first electronic light source 208 and of at least one respective second electronic light source 210.

Alternatively, preferably, the at least one control means 212 may be included in the electronic visual signaling device 206 or be associated with the electronic visual signaling device 206. For example, in this case, a single control means may be sufficient even in the case of a plurality of electromechanical actuators. The single control means of the electronic braking indication system will be able to receive a plurality of braking force F values applied by the plurality of electromechanical actuators and control the switching on of all the first electronic light sources and of all the second electronic light sources.

When a plurality of electromechanical actuators are present, a plurality of force sensor means 204 may be present. Each of these may be arranged to measure a respective value of the braking force F applied by a respective electromechanical actuator.

Each force sensor means may comprise for example a force transducer or a force sensor.

When a plurality of first electronic light sources 208 and second electronic light sources 210 are present, they may be installed in a single electronic visual signaling device 206, or they may be divided into various electronic visual signaling devices.

Preferably, the at least one electronic visual signaling device 206 may be installed on the vehicle such that the at least one first electronic light source 208 and the at least one second electronic light source 210 are visible from outside the vehicle. In this way, when the vehicle is for example in a station, before departure, the driver will be able to release the braking. Once the braking release command has been given, an operator positioned outside the vehicle will take care of viewing all the first and second electronic light sources 208, 210 and checking that all the first electronic light sources 208 are on and that all second electronic light sources 210 are off (this condition being indicative of the occurred release of the braking by all the electromechanical actuators). If there is a second electronic light source 210 switched on, even when the braking release command has been given by the driver, the operator can signal that an electromechanical actuator has remained blocked in a braking condition or in any case he/she can signal the presence of an anomaly.

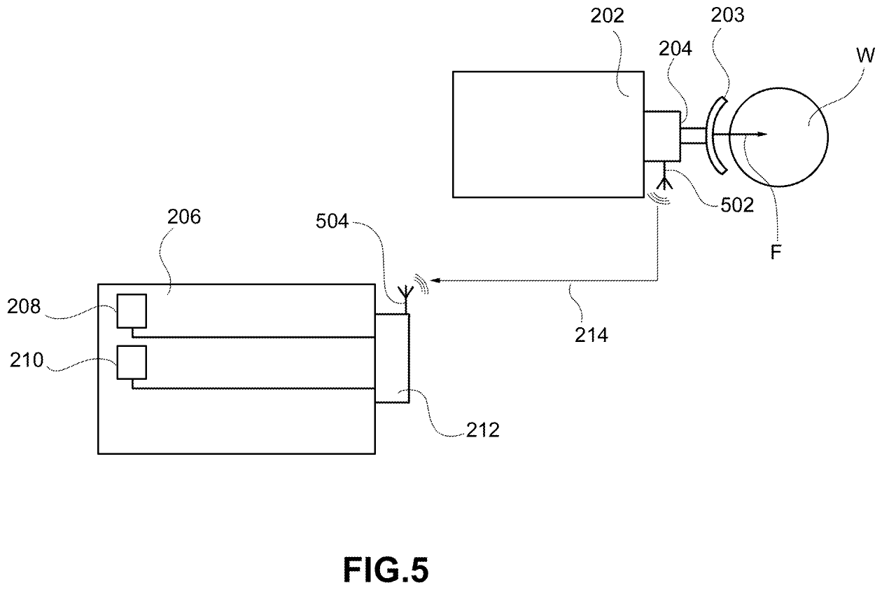

Preferably, the measured value of the braking force F may be provided by the at least one force sensor means 204 to the at least one control means 212 via a communication channel 214. For example, as can be seen in FIG. 5, the communication channel 214 may be a wireless communication channel.

In further embodiments, the communication channel 214 may be a hardwired channel.

The communication channel 214 may be based on the “black channel” protocol.

The communication channel 214 may be implemented according to a safety integrity level (SIL) greater than a predetermined minimum safety integrity level.

Preferably, as can be seen in FIG. 5, the electronic braking indication system for at least one vehicle may comprise a first communication means 502 associated with said at least one force sensor means 204. The first communication means may be arranged to allow the transmission/reception of signals on/from said communication channel 214. Furthermore, the electronic braking indication system for at least one vehicle may comprise a second communication means 504 associated with said at least one control means 212 and arranged to allow the transmission/reception of signals on/from said communication channel 214.

For example, the first communication means 502 and the second communication means 504 may each comprise at least one antenna.

Preferably, the first communication means 502 associated with said at least one force sensor means 204 may be arranged to transmit a first signal indicative of the measured value of the braking force F continuously over time or according to a predetermined transmission period T.

Preferably, when the vehicle is traveling at a speed lower than or equal to a predetermined speed, the first communication means 502 associated with said at least one force sensor means 204 may be arranged to transmit to the second communication means 504, via said communication channel 214, a first signal indicative of the value of the braking force F continuously over time or according to a predetermined transmission period T. Preferably, the at least one control means 212, via the second communication means 504, will be able to send one or more signals indicative of the on/off status of the first electric light sources 208 and of the second electronic light sources 210 present to a remote control station or to an operator's user device. In this way, any maintenance required to repair any blocked or malfunctioning electromechanical actuator may be planned more easily by the staff of the remote station or by the operator provided with a user device.

Preferably, the at least one control means 212 may be arranged to switch off the at least one first electronic light source 208 and/or the at least one second electronic light source 210 when the vehicle has reached or exceeded a predetermined speed. Or, the at least one control means 212 may be arranged to prevent activation of said at least one first electronic light source 208 and/or said at least one second electronic light source 210 when the vehicle has reached or exceeded a predetermined speed.

In other words, when the vehicle is traveling along a section at a speed exceeding a predetermined threshold, it is not necessary for the at least one signaling device 206 to provide visual information regarding the release of the braking since there would be no operator capable to view them. To save energy, the at least one first electronic light source 208 and/or the at least one second electronic light source 210 can be kept off.

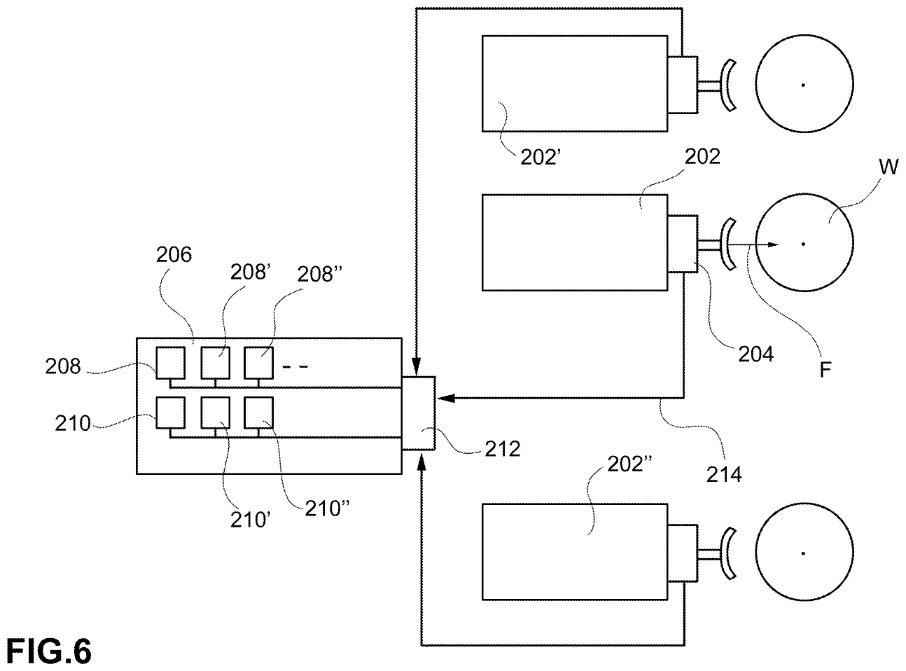

Preferably, as can be seen in FIG. 6, the at least one visual signaling device 206 may comprise respective first electronic light sources 208, 208′, 208″ and second electronic light sources 210, 210′, 210″ for each electromechanical actuator of the vehicle 202, 202′, 202″.

For example, the various electronic light sources may be arranged in a checkerboard or matrix or vector arrangement.

Preferably, each first electronic light source 208 may comprise at least one LED and/or each second electronic light source 210 may comprise at least one LED.

In further embodiments, each first electronic light source 208 and/or each second electronic light source 210 may be made according to further technologies, for example incandescent bulbs, neon lamps, or the like.

Preferably, the at least one electronic visual signaling device 206 may comprise a circuit board on which the first electronic light source 208 and/or the second electronic light source 210 may be installed (also all the first electronic light sources 208 and/or all the second electronic light sources, when present, may be installed on said circuit board).

Preferably, the at least one electronic visual signaling device 206 may further comprise a logic circuit arranged to implement a predetermined control logic. In an example of control logic, the vehicle may comprise a plurality of electromechanical actuators 202, for example four electromechanical actuators arranged to apply respective braking forces F on four different wheels W of the vehicle or on four braking elements each associated with at least one wheel W of the vehicle or with four axles to which wheels are mounted. The four wheels, or four braking elements, or the four axles, may for example be included in the same bogie of the vehicle.

For each electromechanical actuator present, the at least one electronic visual signaling device 206 may comprise a respective first electronic light source 208 and a respective second electronic light source 210. In the present example, since there are four electromechanical actuators, the at least one electronic visual signaling device may comprise four first electronic light sources and four second electronic light sources. By means of the logic circuit, it is possible for example to allow the switching on of all the second electronic light sources when at least one control means commands the switching on of a second electronic light source because the electromechanical actuator (associated with this second electronic light source) has applied a braking force higher than the first threshold THRESHOLD 1 (or than the second threshold THRESHOLD 2, when present). This control logic allows, for example, for better identification of the bogie that is having a braking release problem due to its own electromechanical actuator.

Clearly, different control logics may also be implemented with respect to the one just described.

For example, the logic circuit may include one or more logic gates.

Alternatively, when a control means 212 is included in an electronic visual signaling device 206, it may itself be in charge of implementing a control logic.

Preferably, the electronic braking indication system may comprise a suitable battery arranged to supply electrical energy to the at least one electronic visual signaling device 206, to the at least one first electronic light source 208 (e.g. to each first electronic light source present) and to the at least one second electronic light source (e.g. to each second electronic light source present).

Or, the at least one electronic visual signaling device, the at least one first electronic light source (e.g. each first electronic light source present) and the at least one second electronic light source (e.g. each second electronic light source present) may be arranged to receive electrical energy directly from a battery of the vehicle.

An embodiment example of a possible electromechanical actuator is given below by way of example.

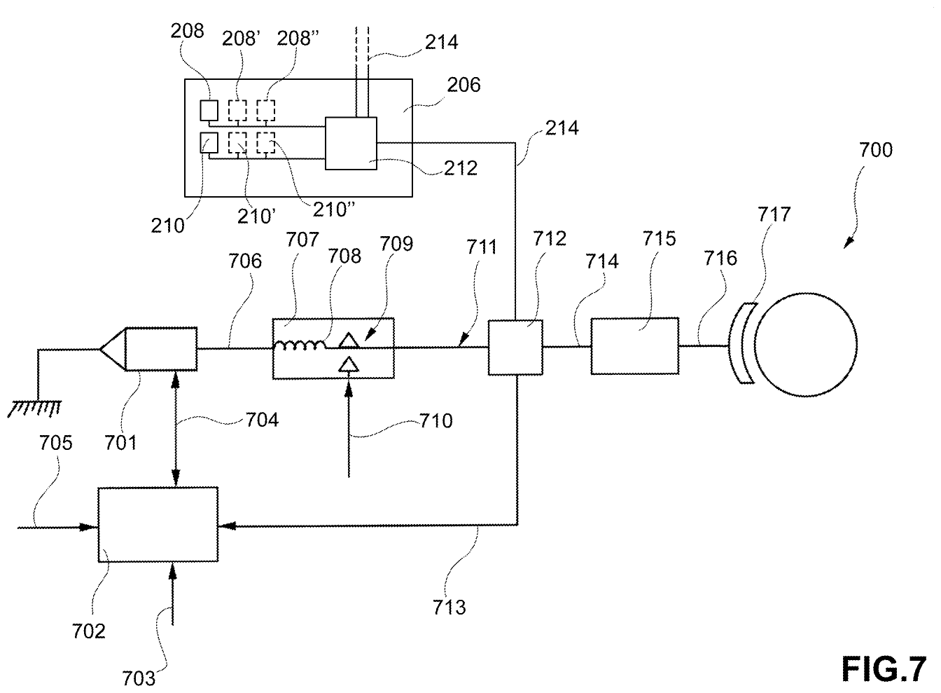

With reference to FIG. 7, an exemplary embodiment of an electromechanical braking actuator 700 according to the prior art is illustrated.

The electromechanical actuator may comprise a first electromechanical module 701 which may comprise at least one electric motor and possibly a speed reducer, i.e., torque multiplier, may extend or retract an arm 706 connected to an emergency braking module 707.

The emergency braking module 707 may comprise emergency braking energy storage means 708, for example a potential mechanical energy mechanical storage means. The mechanical means for storing potential mechanical energy is, by way of non-exclusive example, a helical spring. The emergency braking module 707 may further comprise emergency braking energy release means 709, for example an electromechanical retention mechanism, controlled by an emergency braking request signal 710. The emergency braking energy release means 709 may be arranged to have a first state in which they maintain the potential mechanical energy previously stored in the emergency braking energy storage means 708 when the emergency braking request signal 710 does not indicate a request for emergency braking. The emergency braking energy release means 709 are arranged to have a second state in which they release the potential mechanical energy previously stored in the emergency braking energy storage means 708 when the emergency braking request signal 710 indicates a request for emergency braking.

Other forms of mechanical energy storage may be used, such as, by way of non-exclusive example, a spring of the flat spiral type in case the transfer of forces is of the rotational rather than translational type.

Still further, the stored energy may be kinetic energy stored in a flywheel kept in adequate rotation by a second motor, not shown in the figure.

The force sensor 204 of the electronic braking indication system for at least one vehicle that is the object of the present invention may be constrained for example to an arm 711 (the force sensor is indicated with the reference numeral 712 in FIG. 7). The force sensor may generate an electrical signal 713 indicative of the braking force. This signal may be indicative of the mechanical force applied between the arms 711 and 714. The electrical signal 713, in addition to being supplied to the control means of the electronic braking indication system for at least one vehicle that is the object of the present invention, may be input to a control unit for the service braking 702.

An arm 714 may be connected between the force sensor means 712 and a backlash recuperator 715 which transmits the force to a last arm 716 connected to the pad holder plus brake pad assembly 717.

The backlash recuperator 715 has the purpose of continuously recuperating the wear of the braking pad.

The consumption of the pad may also be recuperated by means of software procedures carried out by the control unit, said procedures not being covered by this invention.

The service braking control unit 702, being electronic in nature, may receive at its input a power supply voltage 705 not exclusively originating from the battery of the vehicle.

The service braking control unit 702 may be arranged to modulate the supply voltage 705 to control the electric motor included in the electromechanical module 701 through at least one electric control signal 704.

The service braking control unit 702 may receive an input signal indicating a service braking force request 703 and may be arranged to apply a service braking force corresponding to said service braking force request 703, controlling the electromechanical module 701 to extend the arm 706 until the electrical signal 713 indicative of braking force indicates that the braking force corresponding to the service braking force request 703 has been reached.

It is known that the connection sequence in which the modules 701, 707, 712, 715 are connected may change according to design and manufacturing expedience.

The previously described electromechanical actuator 700 has been provided only by way of example and is only one of the possible electromechanical actuators with which the electronic braking indication system for at least one vehicle that is the object of the present invention may be associated. The present invention is in fact applicable to any type of electromechanical actuator.

In the following, respective braking indication methods for at least one vehicle are described by way of example.

In a first example, the method comprises the steps of:
measuring a value of braking force F applied by at least one electromechanical actuator of the vehicle 202 to at least one wheel W of the vehicle or to at least one braking element associated with at least one wheel W of the vehicle or an axle to which at least one wheel W is mounted;
switching on a first electronic light source 208, e.g. of an electronic visual signaling device 206, when said measured value of the braking force F is lower than a first threshold (THRESHOLD 1);
switching on a second electronic light source 210, e.g. of the electronic visual signaling device 206, when the measured value of the braking force F is greater than said first threshold (THRESHOLD 1).

In a second example, the method comprises the steps of:
measuring a value of braking force F applied by at least one electromechanical actuator of the vehicle 202 to at least one wheel W of the vehicle or to at least one braking element associated with at least one wheel W of the vehicle or an axle to which at least one wheel W is mounted;
switching on a first electronic light source 208, e.g. of an electronic visual signaling device 206, when said measured value of the braking force F is lower than or equal to a first threshold (THRESHOLD 1);
switching on a second electronic light source 210, e.g. of the electronic visual signaling device 206, when said measured value of the braking force F is greater than or equal to a second threshold (THRESHOLD 2) different from said first threshold (THRESHOLD 1).

The aforesaid methods may be implemented by at least one control means or computer.

The embodiments described above for the electronic braking indication system for at least one vehicle, where possible, are also applicable to the methods described above by way of example.

Moreover, in a further aspect, the present invention relates to a vehicle.

The vehicle comprises at least one electromechanical actuator 202 arranged to apply a braking force F to at least one wheel W of the vehicle or to at least one braking element associated with at least one wheel W of the vehicle or an axle to which at least one wheel W of the vehicle is mounted. The vehicle further comprises an electronic braking indication system according to any one of the embodiments described above.

The present invention is applicable to at least one vehicle. Therefore, the present invention also applies to a plurality of vehicles, for example it may be applicable to a plurality of vehicles connected to each other to create a convoy, for example a convoy of railway vehicles.

As described above, the present invention is particularly applicable to the field of railway vehicles/trains that travel on railway tracks. For example, a vehicle referred to herein may be a locomotive or a wagon, and a route/section may include rails on which the wheels of the locomotive roll. The embodiments described herein are not intended to be limited to vehicles on tracks. For example, the vehicle may be a car, a truck (for example a highway semi-trailer truck, a mining truck, a truck for transporting timber or the like) or the like, and the route may be a road or a trail. For example, a train may comprise a plurality of such vehicles connected or associated with each other.

Various aspects and embodiments of an electronic braking indication system for at least one vehicle, particularly at least one railway vehicle, and of a vehicle according to the invention have been described. It is understood that each embodiment may be combined with any other embodiment. Moreover, the invention is not limited to the embodiments described, but may be varied within the scope defined by the appended claims.

1. An electronic braking indication system for at least one vehicle, particularly at least one railway vehicle, wherein said vehicle comprises at least one electromechanical actuator (202) arranged to apply a braking force (F) to at least one wheel (W) of the vehicle or to at least one braking element associated with at least one wheel (W) of the vehicle or an axle to which at least one wheel (W) is mounted;
said electronic braking indication system comprising:
at least one force sensor means (204) arranged to measure a value of said braking force (F) applied by said at least one electromechanical actuator (202);
at least one electronic visual signaling device (206), comprising at least one first electronic light source (208) and at least one second electronic light source (210);
at least one control means (212) arranged to receive the measured value of said braking force (F) and:
a) switch on said first electronic light source (208) when said measured value of the braking force (F) is lower than a first threshold (THRESHOLD 1);
b) switch on said second electronic light source (210) when said measured value of the braking force (F) is greater than said first threshold (THRESHOLD 1).

2. An electronic braking indication system for at least one vehicle, particularly at least one railway vehicle, wherein said vehicle comprises at least one electromechanical actuator (202) arranged to apply a braking force (F) to at least one wheel (W) of the vehicle or to at least one braking element associated with at least one wheel (W) of the vehicle or an axle to which at least one wheel (W) is mounted;
said electronic braking indication system comprising:
at least one force sensor means (204) arranged to measure a value of said braking force (F) applied by said at least one electromechanical actuator (202);
at least one electronic visual signaling device (206), comprising at least one first electronic light source (208) and at least one second electronic light source (210);
at least one control means (212) arranged to receive the measured value of said braking force (F) and:
a) switch on said first electronic light source (208) when said measured value of the braking force (F) is lower than or equal to a first threshold (THRESHOLD 1);
b) switch on said second electronic light source (210) when said measured value of the braking force (F) is greater than or equal to a second threshold (THRESHOLD 2) different from said first threshold (THRESHOLD 1).

3. The electronic braking indication system according to claim 2, wherein said second threshold (THRESHOLD 2) is greater than said first threshold (THRESHOLD 1).

4. The electronic braking indication system according to claim 1, wherein said at least one electronic visual signaling device (206) is arranged to be installed outside the vehicle, such that said at least one first electronic light source (208) and said at least one second electronic light source (210) are visible from outside the vehicle.

5. The electronic braking indication system according to claim 1, wherein said measured value of the braking force (F) is provided by the at least one force sensor means (204) to the at least one control means (212) via a communication channel (214).

6. The electronic braking indication system according to claim 5, wherein said communication channel is a wireless communication channel.

7. The electronic braking indication system according to claim 5, comprising:
a first communication means (502) associated with said at least one force sensor means (204) and arranged to allow transmission/reception of signals on/from said communication channel (214);
a second communication means (504) associated with said at least one control means (212) and arranged to allow transmission/reception of signals on/from said communication channel (214).

8. The electronic braking indication system according to claim 7, wherein said first communication means (502) associated with said at least one force sensor means (204) is arranged to transmit a first signal indicative of the measured value of the braking force (F) continuously over time or according to a predetermined transmission period.

9. The electronic braking indication system according to claim 7, wherein
when the vehicle is traveling at a speed lower than or equal to a predetermined speed, said first communication means (502) associated with said at least one force sensor means (204) is arranged to transmit to the second communication means (504), via said communication channel (214), a first signal indicative of the value of the braking force (F) continuously over time or according to a predetermined transmission period.

10. The electronic braking indication system according to claim 1, wherein the at least one control means (212) is arranged to switch off said at least one first electronic light source (208) and/or said at least one second electronic light source (210) when the vehicle has reached or exceeded a predetermined speed,
or
said at least one control means (212) is arranged to prevent activation of said at least one first electronic light source (208) and/or said at least one second electronic light source (210) when the vehicle has reached or exceeded a predetermined speed.

11. The electronic braking indication system according to claim 1, wherein the at least one visual signaling device (206) comprises respective first electronic light sources (208′) and second electronic light sources (210′) for each electromechanical actuator (202′) of the vehicle.

12. The electronic braking indication system according to claim 1, wherein the at least one first electronic light source (208) comprises at least one LED and/or the at least one second electronic light source (210) comprises at least one LED.

13. The electronic braking indication system according to claim 1, wherein the at least one electronic visual signaling device (206) comprises a circuit board on which the at least one first electronic light source (208) and/or the at least one second electronic light source (210) are installed.

14. The electronic braking indication system according to claim 1, comprising a battery arranged to supply electrical energy to the at least one electronic visual signaling device, the at least one first electronic light source and the at least one second electronic light source,
or
wherein said electronic visual signaling device, the at least one first electronic light source and the at least one second electronic light source are arranged to receive electrical energy from a battery of the vehicle.

15. A vehicle comprising:
at least one electromechanical actuator (202) arranged to apply a braking force (F) to at least one wheel (W) of the vehicle or to at least one braking element associated with at least one wheel (W) of the vehicle or an axle to which at least one wheel (W) is mounted;
an electronic braking indication system according to any one of claims 1 to 14.
